(19) United States
(12) Patent Application Publication
(10) Pub. No.: US 2025/0317914 A1
(43) Pub. Date: Oct. 9, 2025

(54) TECHNIQUES FOR DYNAMIC PUNCTURING ON SELECTIVE WIRELESS CLIENTS TO MITIGATE INTERFERENCE

(71) Applicant: QUALCOMM Incorporated, San Diego, CA (US)

(72) Inventors: Veneeth Kumar VUPPU, Mountain House, CA (US); Ahmed Ragab ELSHERIF, San Jose, CA (US); Sandip HOMCHAUDHURI, San Jose, CA (US); Alfred ASTERJADHI, San Diego, CA (US)

(21) Appl. No.: 18/824,766

(22) Filed: Sep. 4, 2024

Related U.S. Application Data
(60) Provisional application No. 63/575,500, filed on Apr. 5, 2024.

(51) Int. Cl. H04W 72/0453; H04L 1/00; H04W 72/20; H04W 72/541

(52) U.S. Cl. CPC H04W 72/0453; H04L 1/0068; H04W 72/20; H04W 72/541

(57) ABSTRACT

This disclosure provides methods, components, devices and systems for techniques for dynamic puncturing on selective wireless clients to mitigate interference. Some aspects more specifically relate to techniques that enable access points (APs) to communicate with some stations (STAs) using a “full BW,” and to communicate with other STAs using a “punctured BW.” For example, an AP may communicate with STAs using a “full BW,” and may receive reports from STAs that indicate interference experienced by (or expected to be experienced by) the respective STAs. For STAs that report no interference, the AP may continue communicating with the STAs using the full BW. Comparatively, for STAs that report interference on one or more sub-bands of the full BW, the AP may transmit a report for a “punctured BW” that omits one or more sub-bands of the full BW that are susceptible to the interference.

### CROSS REFERENCE

The present Application for Patent claims the benefit of U.S. Provisional Patent Application No. 63/575,500 by VUPPU et al., entitled “TECHNIQUES FOR DYNAMIC PUNCTURING ON SELECTIVE WIRELESS CLIENTS TO MITIGATEINTERFERENCE,” filed Apr. 5, 2024, assigned to the assignee hereof, and expressly incorporated by reference herein.

### TECHNICAL FIELD

This disclosure relates generally to wireless communication and, more specifically, to techniques for dynamic puncturing on selective wireless clients to mitigate interference.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

In some WLANs, there may be many wireless devices communicating with one another. For example, in the context of Wi-Fi, there may be many APs deployed in a shopping mall that facilitate wireless communications with multiple STAs. In some cases, there may be some overlap in the geographical coverage areas of different APs. In such cases, STAs positioned within the overlapping area may experience interference if the multiple APs communicate within the same (or overlapping) bandwidth (BW).

### SUMMARY

The systems, methods, and devices of this disclosure each have several innovative aspects, no single one of which is solely responsible for the desirable attributes disclosed herein.

One innovative aspect of the subject matter described in this disclosure may be implemented in a method for wireless communication by a first wireless device. The method may include communicating one or more messages with a second wireless device and a third wireless device via a set of frequency resources spanning a set of multiple sub-bands, receiving, from the second wireless device, a report indicating interference at the second wireless device on at least one sub-band of the set of multiple sub-bands, transmitting, to the second wireless device based on the report, a message comprising a first selected punctured bandwidth bitmap indicating that the first wireless device supports communication over a subset of frequency resources of the set of frequency resources that excludes the at least one sub-band, communicating, during a time interval, with the second wireless device via the subset of frequency resources based on transmitting the message, and communicating, during the time interval, with the third wireless device via the set of frequency resources.

Another innovative aspect of the subject matter described in this disclosure can be implemented in a first wireless device. The first wireless device may include a processing system that includes processor circuitry and memory circuitry that stores code. The processing system may be configured to cause the first wireless device to communicate one or more messages with a second wireless device and a third wireless device via a set of frequency resources spanning a set of multiple sub-bands, receive, from the second wireless device, a report indicating interference at the second wireless device on at least one sub-band of the set of multiple sub-bands, transmit, to the second wireless device based on the report, a message comprising a first selected punctured bandwidth bitmap indicating that the first wireless device supports communication over a subset of frequency resources of the set of frequency resources that excludes the at least one sub-band, communicate, during a time interval, with the second wireless device via the subset of frequency resources based on transmitting the message, and communicate, during the time interval, with the third wireless device via the set of frequency resources.

Another innovative aspect of the subject matter described in this disclosure can be implemented in a first wireless device. The first wireless device may include means for communicating one or more messages with a second wireless device and a third wireless device via a set of frequency resources spanning a set of multiple sub-bands, means for receiving, from the second wireless device, a report indicating interference at the second wireless device on at least one sub-band of the set of multiple sub-bands, means for transmitting, to the second wireless device based on the report, a message comprising a first selected punctured bandwidth bitmap indicating that the first wireless device supports communication over a subset of frequency resources of the set of frequency resources that excludes the at least one sub-band, means for communicating, during a time interval, with the second wireless device via the subset of frequency resources based on transmitting the message, and means for communicating, during the time interval, with the third wireless device via the set of frequency resources.

Another innovative aspect of the subject matter described in this disclosure can be implemented in a non-transitory computer-readable medium storing code. The code may include instructions executable by one or more processors to communicate one or more messages with a second wireless device and a third wireless device via a set of frequency resources spanning a set of multiple sub-bands, receive, from the second wireless device, a report indicating interference at the second wireless device on at least one sub-band of the set of multiple sub-bands, transmit, to the second wireless device based on the report, a message comprising a first selected punctured bandwidth bitmap indicating that the first wireless device supports communication over a subset of frequency resources of the set of frequency resources that excludes the at least one sub-band, communicate, during a time interval, with the second wireless device via the subset of frequency resources based on transmitting the message, and communicate, during the time interval, with the third wireless device via the set of frequency resources.

In some examples of the method, first wireless devices, and non-transitory computer-readable medium described herein, transmitting the message may include operations, features, means, or instructions for transmitting, via the message, an information element (IE) associated with the first wireless device, where the IE indicates the subset of frequency resources using one or more dedicated bit fields for indicating punctured bandwidths (BWs).

In some examples of the method, first wireless devices, and non-transitory computer-readable medium described herein, the message indicating the subset of frequency resources includes a wireless network management (WNM) report and the subset of frequency resources may be indicated via one or more bit fields of the WNM report.

Some examples of the method, first wireless devices, and non-transitory computer-readable medium described herein may further include operations, features, means, or instructions for transmitting, to the second wireless device, a request for information associated with the interference at the second wireless device, where the report may be received in response to the request.

In some examples of the method, first wireless devices, and non-transitory computer-readable medium described herein, the request may be transmitted in accordance with a polling periodicity.

Some examples of the method, first wireless devices, and non-transitory computer-readable medium described herein may further include operations, features, means, or instructions for adjusting the polling periodicity to generate an updated polling periodicity based on receiving the report indicating the interference at the second wireless device and transmitting an additional request to the second wireless device in accordance with the updated polling periodicity.

In some examples of the method, first wireless devices, and non-transitory computer-readable medium described herein, the report includes a collocated interference (CI) report, a BW query report (BQR), or both.

Some examples of the method, first wireless devices, and non-transitory computer-readable medium described herein may further include operations, features, means, or instructions for identifying one or more additional wireless devices positioned within a geographical area associated with the second wireless device and communicating, during the time interval, with the one or more additional wireless devices via the subset of frequency resources based on the report and based on the one or more additional wireless devices being positioned within the same geographical area as the second wireless device.

Some examples of the method, first wireless devices, and non-transitory computer-readable medium described herein may further include operations, features, means, or instructions for receiving, from the second wireless device, a second report indicating interference at the second wireless device within the subset of frequency resources, transmitting, to the second wireless device based on the second report, a second message comprising a second selected punctured bandwidth bitmap indicating that the first wireless device supports communication over a second subset of frequency resources of the set of frequency resources that excludes the at least one sub-band, and communicating, during an additional time interval, with the second wireless device via the second subset of frequency resources based on transmitting the second message.

In some examples of the method, first wireless devices, and non-transitory computer-readable medium described herein, the interference indicated via the report includes interference experienced by the second wireless device due to signals from an additional wireless device, future interference expected to be experienced by the second wireless device due to communications at the second wireless device associated with a different radio access technology (RAT), or both.

In some examples of the method, first wireless devices, and non-transitory computer-readable medium described herein, the first wireless device includes an access point (AP) and the second wireless device, the third wireless device, or both, include stations (STAs).

Another innovative aspect of the subject matter described in this disclosure can be implemented in a method by a second wireless device. The method may include communicating one or more messages with a first wireless device via a set of frequency resources spanning a set of multiple sub-bands, transmitting, to the first wireless device, a report indicating interference at the second wireless device on at least one sub-band of the set of multiple sub-bands, receiving, from the first wireless device based on the report, a message comprising a first selected punctured bandwidth bitmap indicating that the first wireless device supports communication over a subset of frequency resources of the set of frequency resources that excludes the at least one sub-band, and communicating with the first wireless device via the subset of frequency resources based on receiving the message.

Another innovative aspect of the subject matter described in this disclosure can be implemented in a second wireless device. The second wireless device may include a processing system that includes processor circuitry and memory circuitry that stores code. The processing system may be configured to cause the second wireless device to communicate one or more messages with a first wireless device via a set of frequency resources spanning a set of multiple sub-bands, transmit, to the first wireless device, a report indicating interference at the second wireless device on at least one sub-band of the set of multiple sub-bands, receive, from the first wireless device based on the report, a message comprising a first selected punctured bandwidth bitmap indicating that the first wireless device supports communication over a subset of frequency resources of the set of frequency resources that excludes the at least one sub-band, and communicate with the first wireless device via the subset of frequency resources based on receiving the message.

Another innovative aspect of the subject matter described in this disclosure can be implemented in a second wireless device. The second wireless device may include means for communicating one or more messages with a first wireless device via a set of frequency resources spanning a set of multiple sub-bands, means for transmitting, to the first wireless device, a report indicating interference at the second wireless device on at least one sub-band of the set of multiple sub-bands, means for receiving, from the first wireless device based on the report, a message comprising a first selected punctured bandwidth bitmap indicating that the first wireless device supports communication over a subset of frequency resources of the set of frequency resources that excludes the at least one sub-band, and means for communicating with the first wireless device via the subset of frequency resources based on receiving the message.

Another innovative aspect of the subject matter described in this disclosure can be implemented in a non-transitory computer-readable medium storing code. The code may include instructions executable by one or more processors to communicate one or more messages with a first wireless device via a set of frequency resources spanning a set of multiple sub-bands, transmit, to the first wireless device, a report indicating interference at the second wireless device on at least one sub-band of the set of multiple sub-bands, receive, from the first wireless device based on the report, a message comprising a first selected punctured bandwidth bitmap indicating that the first wireless device supports communication over a subset of frequency resources of the set of frequency resources that excludes the at least one sub-band, and communicate with the first wireless device via the subset of frequency resources based on receiving the message.

Some examples of the method, second wireless devices, and non-transitory computer-readable medium described herein may further include operations, features, means, or instructions for performing measurements on signals received from a third wireless device and determining the interference at the second wireless device within the set of frequency resources based on the measurements, where transmitting the report may be based on a level of the interference satisfying a threshold interference level.

Some examples of the method, second wireless devices, and non-transitory computer-readable medium described herein may further include operations, features, means, or instructions for identifying one or more additional messages to be communicated by the second wireless device during a future time interval via a second RAT within the set of frequency resources, where the report indicates expected interference at the second wireless device during the future time interval between the first RAT and the second RAT.

In some examples of the method, second wireless devices, and non-transitory computer-readable medium described herein, the message indicating the subset of frequency resources includes a WNM report and the subset of frequency resources may be indicated via one or more bit fields of the WNM report.

In some examples of the method, second wireless devices, and non-transitory computer-readable medium described herein, the request may be received in accordance with a polling periodicity.

Some examples of the method, second wireless devices, and non-transitory computer-readable medium described herein may further include operations, features, means, or instructions for receiving an additional request from the first wireless device in accordance with a second polling periodicity that adjusted relative to the polling periodicity based on the report indicating the interference at the second wireless device.

Some examples of the method, second wireless devices, and non-transitory computer-readable medium described herein may further include operations, features, means, or instructions for receiving, from the first wireless device, control signaling indicating a reporting configuration for transmitting reports associated with interference at the respective second and third wireless devices, where the report may be transmitted in accordance with the reporting configuration.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a signaling diagram that supports techniques for dynamic puncturing on selective wireless clients to mitigate interference.

FIG. 3 shows an example of a process flow that supports techniques for dynamic puncturing on selective wireless clients to mitigate interference.

FIG. 4 shows a block diagram of an example wireless communication device that supports techniques for dynamic puncturing on selective wireless clients to mitigate interference.

FIG. 5 shows a block diagram of an example wireless communication device that supports techniques for dynamic puncturing on selective wireless clients to mitigate interference.

FIG. 6 shows a flowchart illustrating an example process performable by or at a first wireless device that supports techniques for dynamic puncturing on selective wireless clients to mitigate interference.

FIG. 7 shows a flowchart illustrating an example process performable by or at a second wireless device that supports techniques for dynamic puncturing on selective wireless clients to mitigate interference.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to techniques for “dynamic” handling of punctured bandwidths (BWs). Some aspects more specifically relate to techniques that enable access points (APs) to communicate with some stations (STAs) using a “full BW,” and to communicate with other STAs using a “punctured BW.” For example, an AP may communicate with STAs using a “full BW,” and may receive reports from STAs that indicate interference experienced by (or expected to be experienced by) the respective STAs. The reports may further indicate the specific sub-bands within the full BW that are associated with the interference. For STAs that report no interference, the AP may continue communicating with the STAs using the full BW. Comparatively, for STAs that report interference on one or more sub-bands of the full BW, the AP may transmit a report for a “punctured BW” that omits one or more sub-bands of the full BW that are susceptible to the interference. As such, the AP may communicate with some STAs using the full-BW, and may communicate with other STAs using the punctured BW.

Particular aspects of the subject matter described in this disclosure can be implemented to realize one or more of the following potential advantages. In some examples, by facilitating “dynamic” handling of punctured BWs on a client-by-client (“per-peer”) basis, the described techniques may enable APs to communicate with both “full BWs” and “punctured BWs.” As such, techniques described herein may enable the AP to tailor the frequency resources used for communications with each respective STA based on the interference experienced by (or expected to be experienced by) each respective STA. Therefore, techniques described herein may alleviate interference experienced at some STAs (by communicating with such STAs with punctured BWs), while preventing the need to unnecessarily throttle the BW and/or throughput usable by other STAs that do not experience the interference (by communicating with such STAs using full BWs). As such, techniques described herein may alleviate interference and improve data throughput within the wireless network.

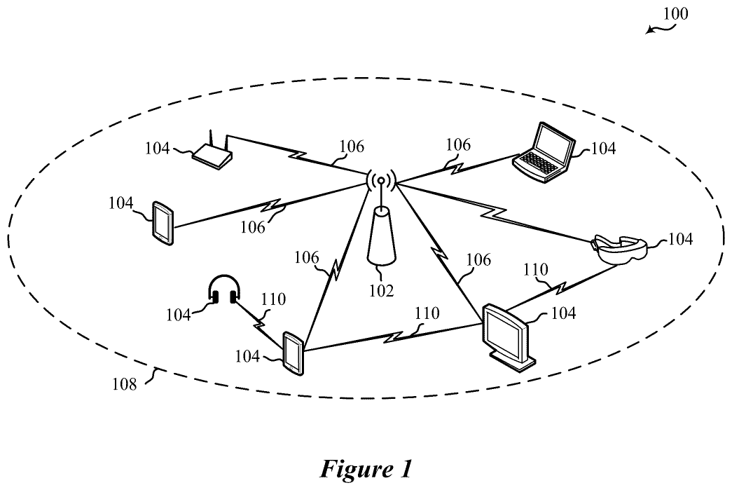

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11bc, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless AP 102 and any number of wireless STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHz-71 GHZ), FR4 (52.6 GHz-114.25 GHZ), and FR5 (114.25 GHZ-300 GHZ).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHZ, 80 MHz, or 160 MHZ portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum BW of 20 MHz, but larger channels can be formed through channel bonding. For example, PPDUs may be transmitted over physical channels having BWs of 40 MHz, 80 MHZ, 160 MHZ, 240 MHZ, 320 MHz, 480 MHZ, or 640 MHz by bonding together multiple 20 MHz channels.

An AP 102 may determine or select an operating or operational BW for the STAs 104 in its BSS and select a range of channels within a band to provide that operating BW. For example, the AP 102 may select sixteen 20 MHz channels that collectively span an operating BW of 320 MHz. Within the operating BW, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion (hereinafter referred to as the “punctured bandwidth”) of a wireless channel exclusive of one or more particular subchannels (e.g., the subchannels that have been excluded by puncturing). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the BW of the channel. For example, if a transmitting device determines (for example, detects, identifies, ascertains, or calculates), in association with a contention operation, that one or more 20 MHZ subchannels of a wider BW wireless channel are busy or otherwise not available, the transmitting device implement puncturing to avoid communicating over the unavailable subchannels while still utilizing the remaining portions of the BW. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a clear channel assessment (CCA) on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a BW portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Retransmission protocols, such as hybrid automatic repeat request (HARQ), also may offer performance gains. A HARQ protocol may support various HARQ signaling between transmitting and receiving wireless communication devices (for example, the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA104 in an OFDMA transmission (hereinafter also referred to as “multi-RU aggregation”). Multi-RU aggregation, which facilitates puncturing and scheduling flexibility, may ultimately reduce latency. As increasing BW is supported by emerging standards (such as the IEEE 802.11be standard amendment supporting 320 MHz and the IEEE 802.11bn standard amendment supporting 480 MHz and 640 MHZ), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large BWs such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the BW between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider BW transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

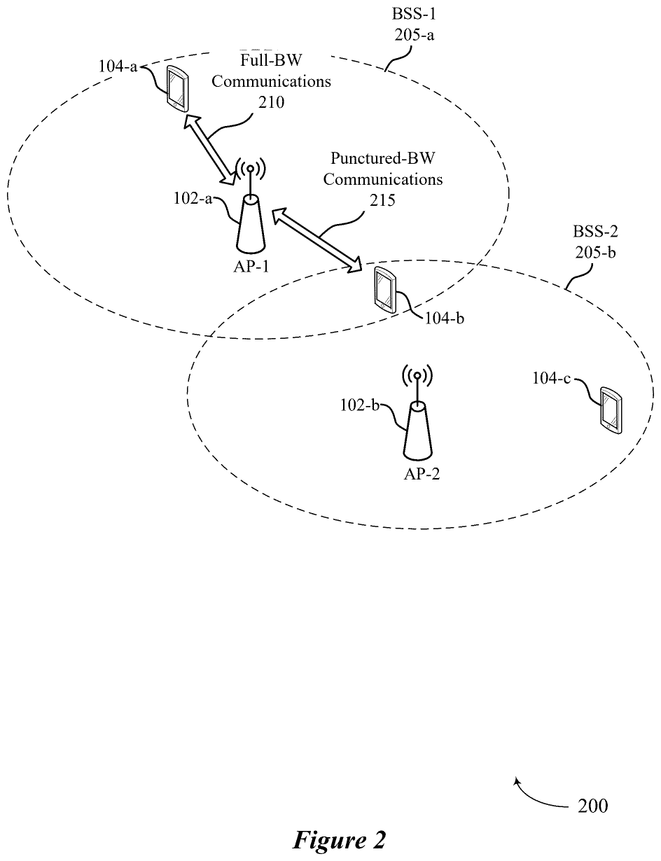

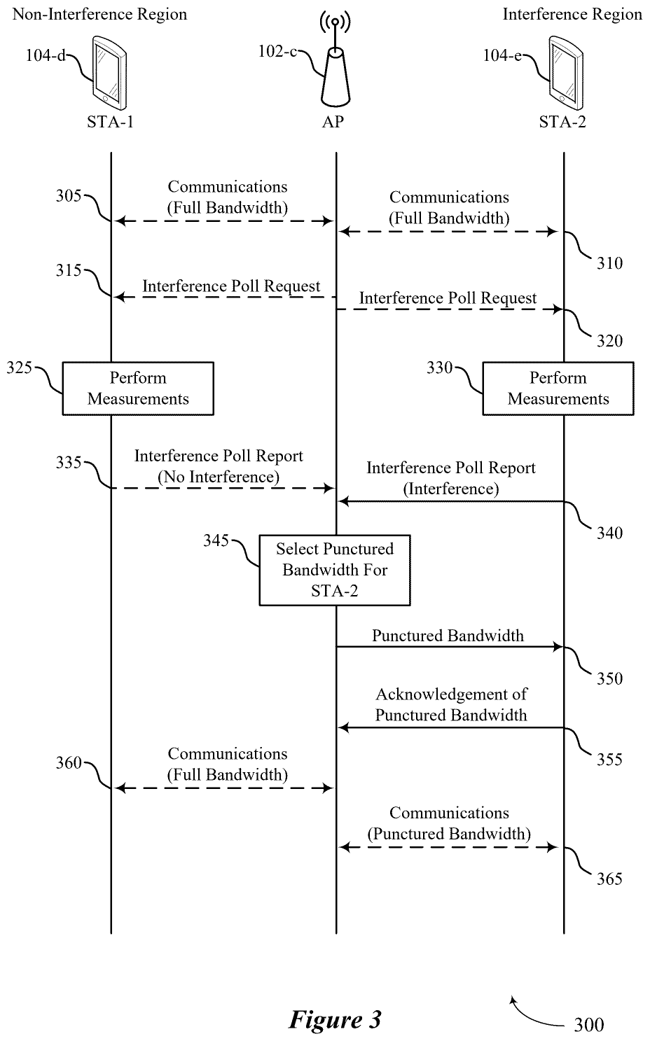

FIG. 2 shows an example of a signaling diagram 200 that supports techniques for dynamic puncturing on selective wireless clients to mitigate interference. Aspects of the signaling diagram 200 may implement, or be implemented by, aspects of the wireless communication network 100. For example, the process flow 300 in FIG. 3 illustrates signaling and configurations for “dynamic” handling of punctured BWs on a per-peer basis, as described previously herein.

The signaling diagram 200 illustrates an example of a WLAN, such as a Wi-Fi network. For example, the signaling diagram 200 may include a first AP 102-a and a second AP 102-b that support wireless communications (e.g., Wi-Fi communications) with one or more STAs 104, such as a first STA 104-a, a second STA 104-b, and a third STA 104-c., a first STA 104-d, and a second STA 104-c, which may be examples of wireless devices as described herein. For example, the AP 102-c illustrated in FIG. 3 may include an example of the first AP 102-a illustrated in FIG. 2.

As noted previously herein, a single AP 102 and an associated set of STAs 104 may be referred to as a BSS 205, which is managed by the respective AP 102. The respective BSSs 205 may be associated with corresponding coverage areas. For example, as shown in FIG. 2, the signaling diagram 200 may include a first BSS 205-a (e.g., BSS-1) that includes the first AP 102-a, the first STA 104-a, and the second STA 104-b, and a second BSS 205-b (e.g., BSS-2) that includes the second AP 102-b, the second STA 104-b, and the third STA 104-c. That is, the second STA 104-b illustrated in FIG. 2 may be associated with (e.g., in wireless communication with) the first AP 102-a, but may be geographically located in the geographical coverage/transmission region of the first BSS 205-a that overlaps with the geographical coverage/transmission region of the second BSS 205-b. As such, while the second STA 104-b may communicate with the first AP 102-a, it may “receive” or otherwise be exposed to communications transmitted by the second AP 102-b. In some cases, the respective APs 104/BSSs 205 may operate in the same or different frequency ranges (e.g., overlapping BWs). As an example, the first BSS 205-a may operate in a larger bandwidth than the second BSS 205-b and the operating bandwidth of the second BSS 205-b may be a subset of the operating bandwidth of the first BSS 205-a. For instance, in some cases, the first STA 104-a and/or the first AP 102-a of the first BSS 205-a may operate in 5GBE80 channel CH100, where the third STA 104-c of the second BSS 205-b may operate in 5GBE20 channels CH100, CH104, CH108, and/or CH112 (or other overlapping channel(s)).

In some environments, there may be many wireless devices communicating with one another. For example, in the context of Wi-Fi, there may be many APs 102 deployed in a shopping mall that facilitate wireless communications with multiple stations STAs 104. In some cases, there may be some overlap in the geographical coverage areas of different APs 102. For example, as shown in FIG. 2, the geographical coverage areas of the respective APs 102-a, 102-b may at least partially overlap. In such cases, STAs 104 positioned within the overlapping area (e.g., the second STA 104-b) may experience interference if the multiple APs 102 communicate within the same BW (and/or overlapping BWs).

To prevent such interference, some APs 102 may be configured to communicate via a “punctured BW,” where the AP 102 omits one or more sub-bands from the BW that are subject to interference. That is, the 802.11be framework may provide an option to configure static puncturing on root AP 102 (e.g., config AP-1 with puncture overlapping 20 MHz channel i.e., AP-2 operating channel).

For example, if the “full BW” of the first AP 102-a includes Wi-Fi channels CH100, CH104, CH108, and CH112, but the second AP 102-b is communicating via channel CH108, the first AP 102-a may communicate using a “punctured BW” that includes channels CH100, CH104, and CH112 (and omits interfering channel CH108). However, according to conventional techniques, the first AP 102-a may apply the punctured BW for all communications at the first AP 102-a. That is, the punctured BW may be applied to communications with all STAs 104 coupled to the first AP 102-a, regardless of whether or not the STAs 104 actually experience the interference from the second AP 102-b on channel CH108. This “static” punctured BW approach may therefore unnecessarily reduce the BW usable by other STAs 104, and may therefore reduce the throughput at the first AP 102-a.

Stated differently, referring to the network topology illustrated in FIG. 2, wireless clients in the “hidden node region” (e.g., region of overlapping coverage of the APs 102-a, 102-b) may experience interference from nearby OBSSs in a subset of its own transmission bandwidth. That is, continuing with the example above, the second STA 104-b in communication with the first AP 102-a may experience interference in channel CH108 due to communications from the second AP 102-b. Interference experienced by wireless clients within the BSS 205-a may impact BSS operation in several ways. For example, traffic collisions at the second STA 104-b may lead to packet decoding errors, and result in more retransmissions being performed between the AP 102-a and the STA 104-b. Such retransmissions between the AP 102-a and the STA 104-b may gradually impact throughput within the BSS 205-a, as the AP 102-a has to dedicate more resources to the retransmissions. As such, the latency of uplink/downlink traffic within the BSS 205-a may spike. Further, as the AP 102-a spends additional time performing retransmissions with the affected client (e.g., STA 104-b), the available airtime for rest of the clients within the BSS 205-a (e.g., STA 104-a) may decrease, and the overall throughput within the BSS 205-a may be impacted.

Accordingly, aspects of the present disclosure are directed to techniques for “dynamic” handling of punctured BWs. In particular, an AP 102 may be able to use a full BW to communicate with STAs 104 that are not subject to interference, and may use a punctured BW to communicate with STAs 104 that are subject to interference. That is, aspects of the present disclosure are directed to per-peer puncturing (e.g., “dynamic” puncturing) instead of the whole-BSS puncturing (e.g., “static” puncturing” described above. For the purposes of the present disclosure, the term “punctured BW” may refer to a BW or set of frequency resources that omits (e.g., “punctures”) one or more sub-bands or channels from a “full BW” (e.g., full set of frequency resources) that experience interference. For instance, if a “full BW” includes channels CH100, CH104, CH108, and CH112, a “punctured BW” may omit at least one of the channels CH100, CH104, CH108, and CH112.

For example, the first AP 102-a may communicate with the STAs 104-a, 104-b using a “full BW,” and may receive reports from the STAs 104 that indicate interference experienced by (or expected to be experienced by) the respective STAs 104. The reports may further indicate the specific sub-bands within the full BW that are associated with the interference. In this example, the first STA 104-a may indicate that it has not (or is not expected) to experience interference from adjacent BSSs 205 (and/or due to other RATs). As such, the first AP 102-a may communicate with the first STA 104-a using the full BW. That is, the first AP 102-a and the first STA 104-a may perform full-BW communications 210 with one another (e.g., Tx/Rx between AP 102-a and STA 104-a are performed across the full BW, assuming STA 104-a is not experiencing interference).

Comparatively, the second STA 104-b may indicate that it is/has experienced (or is expected to experience) interference from adjacent BSSs 205 (and/or due to other RATs). As such, the first AP 102-a may communicate with the second STA 104-b using a punctured BW. That is, the first AP 102-a and the second STA 104-b may perform punctured-BW communications 215 with one another (e.g., Tx/Rx between AP 102-a and STA 104-b are performed within a set of punctured frequency resources, assuming STA 104-b is experiencing interference). In this regard, the AP 102-a may communicate with some STAs 104 (e.g., first STA 104-a) using the full-BW, and may communicate with other STAs 104 (e.g., second STA 104-b) using the punctured BW.

According to the dynamic per-peer puncturing techniques described herein, the first AP 102-a may transmit in the full BW (e.g., full-BW communications 210) for all STAs 104 that are not experiencing interference, and may transmit in a punctured BW (e.g., punctured-BW communications 215) for STAs 104/clients that are experiencing interference. In some cases, the AP 102-a may identify or otherwise identify a selective punctured BW (e.g., punctured BW that omits sub-bands experiencing interference), and may transmit communications within the identified punctured BW to avoid interference.

The dynamic per-peer puncturing techniques described herein may offer several advantages over previous approaches. For example, the per-peer puncturing techniques described herein may result in throughput improvement on clients experiencing interference. That is, STAs 104 experiencing interference (e.g., STA 104-b) may transmit effectively by averting transmission in interference band, thereby reducing the impact of the interference. This may improve throughput between the AP 102-a and the STA 104-b by 25-50% based on interference channel location with respect to the primary channel of the AP 102-a. Additionally, the per-peer puncturing techniques described herein may reduce retransmissions and result in improved airtime. By reducing interference at the STA 104-b, packet decoding errors can be avoided, and thus the AP 102-a can avoid retransmission to the STA 104-b in case of interference. This saved retransmission time can improve available airtime for the AP 102-a to perform other communications/activities.

In some cases, the effectiveness of a punctured BW with improving throughput may be based on which channels/sub-bands are punctured (e.g., omitted) in the punctured BW relative to the primary channel of the AP 102. Stated differently, the effectiveness of puncturing BWs may vary based on how close the detected interference is (and therefore the punctured/omitted channel/sub-band) is to the primary channel in the frequency domain. In particular, interference closer to the primary channel has a larger impact on throughput as compared to interference further from the primary channel. As such, BW puncturing that punctures/omits channels/sub-bands closer to the primary channel may result in higher throughput gains as compared to BW puncturing that punctures/omits channels/sub-bands further from the primary channel. In this regard, the AP 102 may be configured to select punctured/omitted channels/sub-bands for punctured BWs relative to the primary channel in such a manner as to decrease interference and increase throughput gains.

Further, the per-peer puncturing techniques described herein may enable the AP 102-a to perform full-BW communications 210 with STAs 104 that do not experience interference. Clients which are not experiencing interference can continue transmitting within/across the full BW (instead of requiring all STAs 104 to communicate in a punctured BW). As such, by enabling some STAs 104 to continue performing full-BW communications 210, throughput within the BSS 205-a may be improved. Moreover, the per-peer puncturing techniques described herein may result in improved latency. In particular, STAs 104 experiencing interference (e.g., STA 104-b) may exhibit a throughput benefit as well as a latency benefit due to reduced retransmissions by following punctured band transmission (e.g., punctured-BW communications 215 may require fewer retransmissions, resulting in both throughput and latency gains). Lastly, enabling the AP 102-a to simultaneously perform both full-BW communications 210 and punctured-BW communications 215 may result in an improved overall throughput across the BSS 205. In particular, by following a mix of full-BW communications 210 and punctured-BW communications 215 to specific clients, the overall throughput of the BSS 205-a may improve gradually.

In a common dense environment or interference environments, the dynamic BW punctured techniques described herein may enable channels to be effectively utilized by resorting to punctured transmissions for targeted clients (instead of all clients in the BSS 205). That is, clients which do not suffer from interference may continue to perform full-BW communications without any loss.

In order to implement the dynamic puncturing techniques described herein, clients (e.g., STAs 104) may be configured to perform measurements or otherwise detect interference sources on operating frequencies or bandwidths. In other words, the STA 104-b may be configured to measure levels of interference experienced on each of the respective sub-bands of the full BW (e.g., measure interference experienced on each respective channel CH100, CH104, CH108, CH110). Further, the STAs 104 may be configured to relay or report such interference information (e.g., interference source operating channel, BW/sub-bands/channels experiencing interference, interference type, etc.) to the associated AP 102. That is, the STA 104-a may be configured to transmit a report to the AP 102-a, where the report indicates levels of interference experienced on each of the respective channels CH100, CH104, CH108, and CH110. Upon receiving interference reports, the AP 102-a may be configured to signal/indicate and apply dynamic puncturing for specific wireless clients. For instance, as shown in FIG. 2, the AP 102-a may be configured to perform full-BW communications 210 with the first STA 104-a, and perform punctured-BW communications 215 with the second STA 104-b. Further, the APs 102 and/or STAs 104 may be configured to detect persisting interference, and fall back to full-BW communications 210 (e.g., terminate BW puncturing) in cases where the interference goes away, or is otherwise reduced.

In some cases, there may be multiple clients within an interference region. In other words, there may be cases where there are multiple STAs 104 within the overlapping region of the BSSs 205-a, 205-b. In such cases, there may be some STAs 104 within the interference region that have the capability to report interference information to the AP 102-a, where other STAs 104 may not have such reporting capabilities (but can still support BW puncturing). In such cases, the AP 102-a may be configured to estimate interference within the interference/hidden node region, and perform punctured-BW communications 215 for all the STAs 104 within the interference/hidden node region, regardless as to whether the STAs 104 in the interference/hidden node region transmitted an interference report (e.g., external interference from an OBSS). In other words, if the AP 102-a receives an interference report from the STA 104-b, the AP 102-a may assume that other STAs 104 within the same geographical region as the STA 104-b are also experiencing similar interference, and may therefore apply the same/similar punctured BW(s) to all STAs 104 in the same geographical region. As such, STAs 104 that experience interference and have the capability to support punctured BWs can gain advantages of punctured-BW communications 215 and avoid interference with effective puncture mode transmissions.

In some aspects, STAs 104 may be configured to report or communicate the granularity or percent-of-occupancy of interference signals on individual sub-bands to enable the APs 102 to determine accurate channels to avoid interference. That is, the STA 104-b may be configured to report interference levels or percent-of-occupancy metrics for each of channels CH100, CH104, CH108, and CH110 to enable the AP 102-a to accurately select a punctured BW that will avoid/reduce the identified interference. In some cases, STAs 104 may be configured to perform interference probability reporting over time to further facilitate punctured BW selection.

In the context of a multi-coordinated AP network operating the same or overlapping channels (e.g., internal interference OBSS), STAs 104 operating in the hidden node region (e.g., region of overlapping coverage between the BSSs 205) may be configured to communicate interference information (e.g., interference percentages). In such cases, the STAs 104 connected to either APs 102 in the hidden node region can start selecting random puncture bitmaps so that the STAs 104 associated with different APs 102 can transmit in non-overlapping BWs, thereby avoiding internal interference. The STAs 104 may not arrive at non-overlapping puncture BWs the first iteration, but after a few iterations of selecting random puncture BWs, the STAs 104 can arrive at non-overlapping puncture BWs, thereby avoiding internal interference. Stated differently, in some cases, the APs 102 and/or STAs 104 may select bitmaps for punctured BWs in a trail-and-error manner until the wireless devices arrive at punctured BWs that alleviate interference.

For example, AP-1 and STA1 may communicate on an 80 MHz BW with operating channels 36, 40, 44, 48. Similarly, AP-2 and STA2 may operate on the same 80 MHz BW with operating channels 36, 40, 44, 48. In this example, assuming STA1 and STA2 are operating in the hidden node region detect interference, the STAs 104 may select subsets of operating channels in a trail-and-error manner. For instance, in first attempt, STA1 and STA2 may select channels 44-48 as the new operating punctured transmission BW. In this case, since the STAs both selected the same channels, the STAs may again perform a new selection, and may arrive at a combination where STA1 communicates on channels 36-40, and STA2 communicates on channels 44-48. That is, STAs may randomly select punctured BWs in a manner that can be summarized as:

AP1-STA1 BW 80 MHz->Operating channel: 36-40-44-48>>44-48>>36-40
AP2-STA2 BW 80 MHz->Operating channel: 36-40-44-48>>44-48>>44-48

In the example above, if AP1 and AP2 are operating in different channels, but have some overlap, the STAs (STA1, STA2) can request the APs to converge channels so that the STAs can sense other AP transmissions to more effectively select punctured BW bitmaps.

In additional or alternative implementation, aspects of the present disclosure are directed to techniques for mitigating in-device interference with time-based differentiation. That is, techniques described herein may be used to alleviate interference that results from wireless devices communicating according to multiple RATs. For example, in the context of clients that are able to communicate according to multiple RATs (e.g., Bluetooth and Wi-Fi), auxiliary radio transmissions (e.g., Bluetooth) may interfere with Wi-Fi radio transmission. For example, the second STA 104-b may be configured to perform both Bluetooth and Wi-Fi communications. However, in cases where the Bluetooth and Wi-Fi communications are performed over the same/similar frequency resources, the Bluetooth communications may cause interference for the Wi-Fi communications (or vice versa). In this dual/auxiliary radio operation (e.g., multi-RAT operation) where there is minimal channel separation, the STA 104-b may be configured to identify scheduled Bluetooth communications, and may report the information to the AP 102-b to avoid certain bands (e.g., bands used for Bluetooth communications) during certain periods using target wake time (TWT) service periods. In other words, the second STA 104-b may determine that scheduled Bluetooth communications are expected to cause interference at some point in the future, and may report the expected interference to cause the AP 102-a to configure a punctured BW that will alleviate/mitigate the expected interference.

For example, during the service period for Bluetooth communications, the AP 102-a and the STA 104-b may communicate Wi-Fi signals in a punctured mode (e.g., punctured-BW communications 215) to avoid/reduce interference between the Bluetooth and Wi-Fi communications. Conversely, during non-service periods, the devices may communicate Wi-Fi signals in either a full-BW mode or a punctured mode (e.g., full-BW communications 210 and/or punctured-BW communications 215) based on traffic type or sleep patterns.

In this regard, the APs 102 may be configured to select BWs used to communicate with respective STAs 104 on a per-peer basis. That is, the AP 102-a may perform communications with the first STA 104-a using a full BW (e.g., full-BW communications 210), and may perform communications with the second STA 104-b using a punctured BW (e.g., punctured-BW communications 215). In such cases, the full-BW communications 210 and the punctured-BW communications 215 may at least partially overlap in time (e.g., simultaneous communications). Moreover, the AP 102-a may be configured to communicate with multiple different STAs 104 using different punctured BWs. For example, the AP 102-a may communicate with the STA 104-b using a first punctured BW that excludes channel CH104 (e.g., first punctured BW bitmap), and may communicate with an additional STA 104 using a second punctured BW that excludes channel CH108 (e.g., second punctured BW bitmap).

FIG. 3 shows an example of a process flow 300 that supports techniques for dynamic puncturing on selective wireless clients to mitigate interference. Aspects of the process flow 300 may implement, or be implemented by, aspects of the wireless communication network 100, the signaling diagram 200, or both. For example, the process flow 300 illustrates signaling and configurations for “dynamic” handling of punctured BWs on a per-peer basis, as described previously herein.

The process flow 300 includes an AP 102-c, a first STA 104-d, and a second STA 104-c, which may be examples of wireless devices as described herein. For example, the AP 102-c illustrated in FIG. 3 may include an example of the first AP 102-a illustrated in FIG. 2. Similarly, the first STA 104-d and the second STA 104-c illustrated in FIG. 3 may be examples of the first STA 104-a and the second STA 104-b, respectively, as illustrated in FIG. 2. In this regard, the second STA 104-e may be positioned within an interference region (e.g., hidden node region) where coverage areas of neighboring APs 102 overlap. Comparatively, the first STA 104-d may not be positioned in the interference region, and may therefore not be subject to interference from a neighboring AP 102. In this regard, the wireless communications system shown in FIG. 3 may also include a nearby OBSS that causes interference to the second STA 104-e, but not to the first STA 104-d.

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 305, the AP 102-c may perform full-BW communications with the first STA 104-d. Similarly, at 310, the AP 102-c may perform full-BW communications with the second STA 104-e. For example, the AP 102-c may communicate with the STAs 104-d, 104-e using a “full-BW” that includes channels CH100, CH104, CH108, and CH110.

At 315, the AP 102-c may transmit an interference poll request to the first STA 104-d. Similarly, at 320, the AP 102-c may transmit an interference poll request to the second STA 104-e. The AP 102-c may transmit the interference poll report requests at 315 and 320 based on performing the full-BW communications at 305 and 310. The interference poll requests may include information usable by the STAs 104 to report interference to the AP 102-c. For example, the interference poll requests may indicate what types of reports the STAs 104 are to use to report interference, how interference is to be reported across the sub-bands/channels of the full BW, resources for transmitting the interference reports, and the like.

In additional or alternative implementations, AP 102-c may transmit control signaling to the STAs 104-d, 104-e, where the control signaling indicates a reporting configuration usable by the STAs 104 to report interference for punctured BW selection. The reporting configuration may include resources for transmitting interference reports, trigger conditions for transmitting interference reports, and the like. For example, a reporting configuration may cause the STAs 104 to transmit an interference report if measured/expected interference exceeds some threshold interference level. In this regard, STAs 104 may be configured to report interference in response to periodic AP polling, based on proactive client reporting, or both.

In this regard, the STAs 104 may be configured to report interference based on (1) periodic AP polling, and/or (2) proactive client reporting. In the context of periodic AP polling, the AP 102-c may periodically “poll,” or request, all its wireless clients to report interference using collocated interference (CI) reports, BW query report (BQR) polling, or both. In some cases, the AP 102-c may be configured to poll all clients/STAs 104 at periodic intervals. Initially, if the AP 102-c does not identify any interference and/or if the STAs 104 do not report any interference, the periodic poll time (e.g., periodicity for transmitting polls/requests for interference reporting) may be relatively small/short. However, the AP 102-c may gradually or exponentially adjust the polling periodicity as STAs 104 report interference. For example, the AP 102-c may increase the polling periodicity (e.g., shorter duration between interference requests) in response to STAs 104 reporting interference, and may decrease the polling periodicity (e.g., longer duration between interference requests) in response to STAs 104 reporting no interference. In other words, the AP 102-c may adjust the polling periodicity based on whether or not STAs 104 report interference.

In some cases, the AP 102-c may transmit requests to STAs 104 located in different geographical regions with different periodicities based on the interference reported in the respective geographical regions. For example, STAs 104 located in a first geographical area (e.g., interference region) may experience more interference as compared to STAs 104 located in a second geographical area. As such, the AP 102-c may transmit polling requests to STAs 104 located in the first geographical area more frequently as compared to STAs 104 located in the second geographical area.

At 325, the first STA 104-d may measure interference on the respective sub-bands/channels of the full BW. Similarly, at 330, the second STA 104-e may measure interference on the respective sub-bands/channels of the full BW. The STAs 104-d, 104-e may measure the interference at 325 and 330 based on performing the full-BW communications at 305 and 310, receiving the interference poll requests at 315 and 320, or both. For example, the second STA 104-e may measure a level of interference on each of the 100, 104, 108, and 110 channels/sub-bands.

Additionally, or alternatively, the STAs 104 may be configured to measure, estimate, predict, or otherwise identify interference that is expected to be experienced by the STAs 104 at some point in the future. For example, the second STA 104-e may predict or otherwise identify that future Bluetooth communications are expected to cause interference to future Wi-Fi communications.

At 335, the first STA 104-d may transmit an interference poll report to the AP 102-c. Similarly, at 340, the second STA 104-e may transmit an interference poll report to the AP 102-c. The STAs 104-d, 104-e may transmit the interference reports at 335 and 330 based on performing the full-BW communications at 305 and 310, receiving the interference poll requests at 315 and 320, performing the measurements or otherwise identifying/predicting interference at 325 and 330, or any combination thereof.

In the example illustrated in FIG. 3, the interference report received from the first STA 104-d may indicate that the first STA 104-d has not experienced (and/or is not expected to experience) any interference. In other words, the interference report received from the first STA 104-d may indicate that the first STA 104-d is in a clear environment. Conversely, the interference report received from the second STA 104-e may indicate that the second STA 104-e has experienced (and/or is expected to experience) interference. In other words, the second STA 104-e may indicate interference experienced from a nearby OBSS via the interference report at 340. The interference report may include channel frequency and BW information of the interference report (e.g., interference experienced on each respective channel/sub-band, interference type, etc.).

As noted previously herein, the STAs 104 may be configured to report interference based on (1) periodic AP polling, and/or (2) proactive client reporting. In the context of periodic AP polling, the STAs 104-d, 104-e may transmit the poll reports at 335 and 340 in response to periodic polls/requests received from the AP 102-c at 315 and 320. Comparatively, in the context of client proactive reporting, the STAs 104 may be configured to transmit the interference reports in response to a satisfaction of one or more trigger conditions.

For example, a wireless client experiencing retransmissions or packet error rates above certain threshold can anticipate existence of interference, and may proactively perform a site survey to sense nearby channel conditions and report interference existence to the AP 102-c. In such cases, the STAs 104 may be pre-configured with trigger conditions to perform autonomous/proactive interference reporting. In other cases, the AP 102-c may configure the STAs 104 with a reporting configuration that includes trigger conditions for transmitting interference reports. Conversely, if AP 102-c notices more retransmissions occurring to/with the STA 104-e, instead of waiting for the next polling timer to send a new interference poll request and/or instead of expecting proactive client reporting, the AP 102-c may send an ad-hoc interference poll request to the respective STA 104-e to receive a new interference report.

In some aspects, OBSS interference may be reported using multiple mechanisms, including: (1) collocated interference (CI) reporting protocol exchange, and (2) BQR polling exchange, or both. In additional or alternative implementations, vendor-specific packet exchange may be used to initiate and receive interference reports (e.g., in cases where CI reporting and/or BQR polling exchange is insufficient to exchange information associated with internal or external interference).

In the context of CI reporting, the AP 102-c may transmit a CI request frame (e.g., action frame) at steps 315, 320, and the STAs 104 may respond with a CI report frame (action frame) at steps 335, 340. The CI request frames may enable automatic reporting (e.g., automatic report enabled) and report timeout. The CI request frames at 315, 320 may cause the STAs 104 to send a CI report when the respective STA 104 identifies a change in the CI. Additionally, or alternatively, the CI request frames may cause the STAs 104 to send a CI report periodically using the periodicity included in the reporting period/reporting configuration. In other cases, the CI request frame may include a provision to cancel ongoing requests.

Continuing with reference to CI reporting, the CI report frames (e.g., interference reports at 335, 340) may include an interference center frequency field that indicates the center frequency of the identified interference (e.g., in units of 5 kHz). When the center frequency is unknown, the STA 104 may instead report the center frequency of the operating channel at the respective STA 104. The CI report frames may further include an interference BW field that indicates the BW of the interference signal (e.g., in units of 5 kHz at the −3 dB roll-off point). When the BW of the interference signal is unknown, the CI report may be set to some predefined value. The CI report frames may further indicate the interference level of the measured/expected interference. The interference level may indicate the maximum level of the CI power in units of dBm over all Rx chains at the STA 104. An interference index field may be used to indicate the interference index that is unique for each type of interference source.

Comparatively, in the context of BQR polling, a BQR report for reporting interference (e.g., interference reports at 335, 340) may include an available channel bitmap subfield. The available channel bitmap subfield may include a bitmap indicating the subchannels available at the STA 104 transmitting the BQR. For example, each bit in the bitmap may correspond to a 20 MHz sub-channel (e.g., sub-band) within the operating channel width of the BSS in which the STA 104 is associated, with the least significant bit (LSB) corresponding to the lowest numbered operating sub-channel/sub-band of the BSS. The bit in position X in the bitmap may be set to 1 to indicate that the subchannel X+1 is idle; otherwise, it is set to 0 to indicate that the subchannel is busy or unavailable. Availability of each 20 MHz sub-channel/sub-band may be based on an ED-based CCA procedure, and may be reported for the 20 MHz sub-channels located in the operating channel of the reporting STA 104.

Continuing with reference to BQR operation, the STAs 104 may send BQRs (at 335, 340) to assist the AP 102-c in allocating downlink MU and uplink MU resources. The STAs 104 may either implicitly deliver BQRs in the BQR control subfield of a frame transmitted to the AP 102-c (e.g., unsolicited BQR), or explicitly deliver BQRs in a frame sent to the AP 102-c in response to a BQRP trigger frame received at 315 and 320 (e.g., solicited BQR). The STAs 104 may be configured to transmit an unsolicited BQR in response to certain trigger frames except NFRP, MU-RTS, and BQR polling (with or without RA-RUs), or may send the unsolicited BQR after accessing the WM using EDCA.

Stated differently, STAs 104 may be configured with time-based triggers (e.g., periodic AP polling) and/or event-based triggers (e.g., proactive client reporting) for transmitting interference reports. For time-based triggers, the AP 102 may choose a periodic time (e.g., polling periodicity) to poll the STAs 104 to retrieve channel conditions either by using Collocated channel interference report (e.g., CI report) or BQR polling procedure. As described previously herein, the periodic timer (e.g., polling periodicity) can be selectively adjusted based on whether or not the STAs 104 report interference. Conversely, with event-based triggering, the STAs 104 may be configured to transmit CI reports of BQRs if certain trigger conditions are satisfied (e.g., the PER/BA failure errors exceed certain thresholds).

At 345, the AP 102-c may select a punctured BW that will be used for wireless communications with the second STA 104-e. The AP 102-c may select the punctured BW based on the interference report (e.g., CI report, BQR) received from the second STA 104-e at 340. For example, in cases where the interference report at 340 indicates that there is no interference on channels/sub-bands CH100, CH104, and CH110, but indicates interference on channel CH108, the AP 102-c may select a punctured BW that includes channels/sub-bands CH100, CH104, and CH110 (and excludes/omits channel CH108).

In some aspects, after performing measurements at 330, the STA 104-e may be configured to identify which frequency sub-bands (e.g., which frequency channels) experience interference (e.g., which sub-bands should be avoided), and may transmit a suggested punctured BW bitmap to the AP 102-c via the interference report. In such cases, the AP 102-c may select the punctured BW at 345 based on the suggested punctured BW (e.g., suggested bitmap) received from the STA 104-e via the interference report.

At 350, the AP 102-c may transmit a message to the second STA 104-e that indicates the punctured BW selected at 345. That is, the AP 102-c may send a selective punctured BW bitmap to indicate that the AP 102-c is ready to transmit in the punctured BW to avoid interference at the STA 104-e from a nearby OBSS.

In some cases, the message at 350 may include a vendor-specific information element (IE) that is used to indicate a bitmap of the selected punctured BW based on the channel interference report received from the STA 104-c. In additional or alternative implementations, the selected punctured BW may be indicated via a wireless network management (WNM) report. For example, WNM reporting may include vendor-specific event requests and reports. In such cases, bit fields within the WNM reports may be repurposed or otherwise used to indicate the selected punctured BW at 350.

At 355, the STA 104-e may transmit an ACK or other feedback message indicating whether or not the STA 104-e supports communications (e.g., Rx/Tx) on the punctured BW indicated at 355.

In additional or alternative implementations, the STA 104-e may request that the AP 102-c select a new/different punctured BW bitmap. In particular, the STA 104-c may determine which punctured BW (e.g., which bitmap) is properly/best suited for communications between the STA 104-e and the AP 102-c to mitigate experienced interference and/or mitigate future expected interference. In such cases, the AP 102-c and the STA 104-e may exchange signaling back and forth until the devices agree or otherwise identify a punctured BW (e.g., punctured BW bitmap) that will be used.

At 360, the AP 102-c and the first STA 104-d may communicate with one another on the full BW. That is, because the STA 104-d did not report any interference via the report at 335, the wireless devices may continue communicating via the full BW.

At 365, the AP 102-c and the second STA 104-e may communicate with one another via the selected punctured BW. In this regard, the AP 102-c and the second STA 104-e may communicate with one another via the punctured BW at 365 based on selecting the punctured BW at 345, transmitting/receiving the indication of the punctured BW at 350, receiving/transmitting the ACK of the punctured BW at 355, or any combination thereof. In some aspects, the full-BW communications at 360 and the punctured-BW communications at 365 may at least partially overlap in time. That is, the AP 102-c may be configured to perform simultaneous full-BW and punctured-BW communications with different STAs 104.

As described previously herein, the wireless devices may support mechanisms to detect persisting interference, and to fall back to full BW communications once detected interference disappears or otherwise decreases. For example, in some cases, the AP 102-c may continue to periodically poll STAs 104 (as described in steps 315, 320) to check for interference and to determine if the interference persists. If any existing STAs 104 transmitting in dynamic punctured BWs report or otherwise identify decreased interference for a continued duration, then the AP 102-c and/or STA 104 may request or indicate for the wireless devices to fall back to full BW communications. Conversely, the AP 102-c may select a new puncture bitmap if there is any change in the interference experienced by STA 104-e either due to a decrease in interference to lesser sub-bands and/or an increase in interference in other sub-bands.

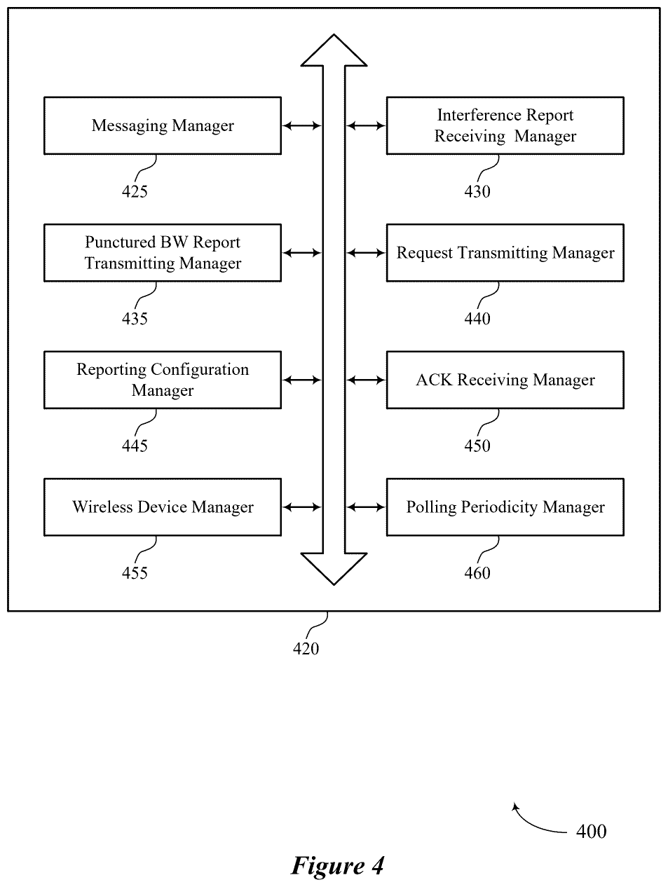

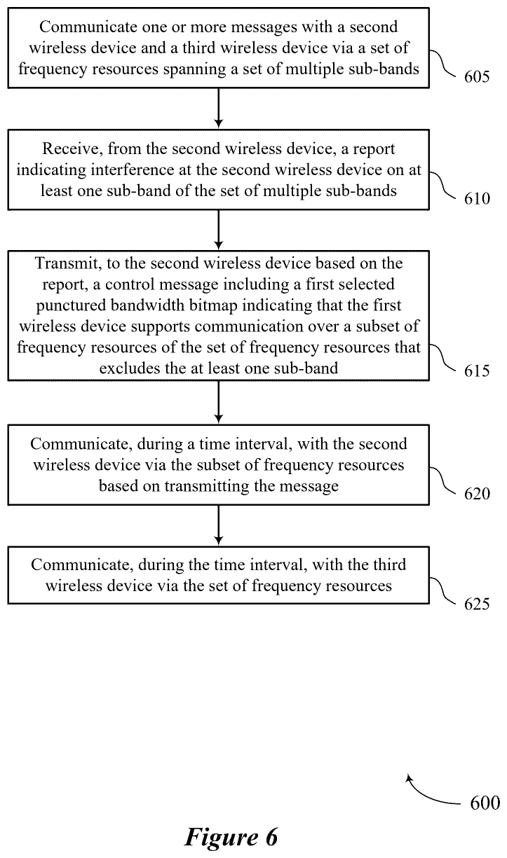

FIG. 4 shows a block diagram of an example wireless communication device 400 that supports techniques for dynamic puncturing on selective wireless clients to mitigate interference. In some examples, the wireless communication device 400 is configured to perform the process 600 described with reference to FIG. 6. The wireless communication device 400 may include one or more chips, SoCs, chipsets, packages, components or devices that individually or collectively constitute or include a processing system. The processing system may interface with other components of the wireless communication device 400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 400 may transmit the information output from the chip. In such an example, the second interface may refer to an interface between the processing system of the chip and a reception component, such that the wireless communication device 400 may receive information that is then passed to the processing system. In some such examples, the first interface also may obtain information, such as from the transmission component, and the second interface also may output information, such as to the reception component.

The processing system of the wireless communication device 400 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 400 can be configurable or configured for use in an AP, such as the AP 102 described with reference to FIG. 1. In some other examples, the wireless communication device 400 can be an AP that includes such a processing system and other components including multiple antennas. The wireless communication device 400 is capable of transmitting and receiving wireless communications in the form of, for example, wireless packets. For example, the wireless communication device 400 can be configurable or configured to transmit and receive packets in the form of physical layer PPDUs and MPDUs conforming to one or more of the IEEE 802.11 family of wireless communication protocol standards. In some other examples, the wireless communication device 400 can be configurable or configured to transmit and receive signals and communications conforming to one or more 3GPP specifications including those for 5G NR or 6G. In some examples, the wireless communication device 400 also includes or can be coupled with one or more application processors which may be further coupled with one or more other memories. In some examples, the wireless communication device 400 further includes at least one external network interface coupled with the processing system that enables communication with a core network or backhaul network that enables the wireless communication device 400 to gain access to external networks including the Internet.

The wireless communication device 400 includes a messaging manager 425, an interference report receiving manager 430, a punctured BW report transmitting manager 435, a request transmitting manager 440, a reporting configuration manager 445, an ACK receiving manager 450, a wireless device manager 455, and a polling periodicity manager 460. Portions of one or more of the messaging manager 425, the interference report receiving manager 430, the punctured BW report transmitting manager 435, the request transmitting manager 440, the reporting configuration manager 445, the ACK receiving manager 450, the wireless device manager 455, and the polling periodicity manager 460 may be implemented at least in part in hardware or firmware. For example, one or more of the messaging manager 425, the interference report receiving manager 430, the punctured BW report transmitting manager 435, the request transmitting manager 440, the reporting configuration manager 445, the ACK receiving manager 450, the wireless device manager 455, and the polling periodicity manager 460 may be implemented at least in part by at least a processor or a modem. In some examples, portions of one or more of the messaging manager 425, the interference report receiving manager 430, the punctured BW report transmitting manager 435, the request transmitting manager 440, the reporting configuration manager 445, the ACK receiving manager 450, the wireless device manager 455, and the polling periodicity manager 460 may be implemented at least in part by a processor and software in the form of processor-executable code stored in memory.

The messaging manager 425 is configurable or configured to communicate one or more messages with a second wireless device and a third wireless device via a set of frequency resources spanning a set of multiple sub-bands. The interference report receiving manager 430 is configurable or configured to receive, from the second wireless device, a report indicating interference at the second wireless device on at least one sub-band of the set of multiple sub-bands. The punctured BW report transmitting manager 435 is configurable or configured to transmit, to the second wireless device based on the report, a control message comprising a first selected punctured bandwidth bitmap indicating that the first wireless device supports communication over a subset of frequency resources of the set of frequency resources that excludes the at least one sub-band. In some examples, the messaging manager 425 is configurable or configured to communicate, during a time interval, with the second wireless device via the subset of frequency resources based on transmitting the control message. In some examples, the messaging manager 425 is configurable or configured to communicate, during the time interval, with the third wireless device via the set of frequency resources.

In some examples, to support transmitting the control message, the punctured BW report transmitting manager 435 is configurable or configured to transmit, via the control message, an IE associated with the first wireless device, where the IE indicates the subset of frequency resources using one or more dedicated bit fields for indicating punctured BWs.

In some examples, the control message indicating the subset of frequency resources includes a WNM report. In some examples, the subset of frequency resources are indicated via one or more bit fields of the WNM report.

In some examples, the request transmitting manager 440 is configurable or configured to transmit, to the second wireless device, a request for information associated with the interference at the second wireless device, where the report is received in response to the request.

In some examples, the request is transmitted in accordance with a polling periodicity.

In some examples, the polling periodicity manager 460 is configurable or configured to adjust the polling periodicity to generate an updated polling periodicity based on receiving the report indicating the interference at the second wireless device. In some examples, the request transmitting manager 440 is configurable or configured to transmit an additional request to the second wireless device in accordance with the updated polling periodicity.

In some examples, the request transmitting manager 440 is configurable or configured to transmit, to the second wireless device, a first set of requests for information associated with the interference at the second wireless device, where the report is received in response to the first set of requests, and where the first set of requests are transmitted in accordance with a first polling periodicity associated with a first geographical area of the second wireless device relative to the first wireless device. In some examples, the request transmitting manager 440 is configurable or configured to transmit, to the third wireless device, a second set of requests for information associated with interference at the third wireless device, where the second set of requests are transmitted in accordance with a second polling periodicity associated with a second geographical area of the third wireless device relative to the first wireless device, the second polling periodicity different from the first polling periodicity.

In some examples, the first polling periodicity is based on one or more reports indicating interference at wireless devices positioned within the first geographical area. In some examples, the second polling periodicity is based on one or more additional reports indicating interference at wireless devices positioned within the second geographical area.

In some examples, the reporting configuration manager 445 is configurable or configured to transmit, to the second wireless device, the third wireless device, or both, control signaling indicating a reporting configuration for transmitting reports associated with interference at the respective second and third wireless devices, where the report is received in accordance with the reporting configuration.

In some examples, the report includes a CI report, a BQR, or both.

In some examples, the In some examples, the punctured BW report transmitting manager 435 is configurable or configured to transmit, to the third wireless device based at least in part on a second report from the third wireless device, a control message comprising a second selected punctured bandwidth bitmap indicating that the first wireless device supports communication over the set of frequency resources, wherein the first selected punctured bandwidth bitmap and the second selected punctured bandwidth bitmap are different.

In some examples, the ACK receiving manager 450 is configurable or configured to receive, from the second wireless device, an ACK of the subset of frequency resources, where communicating with the second wireless device during the time interval via the subset of frequency resources is based on receiving the ACK.

In some examples, the wireless device manager 455 is configurable or configured to identify one or more additional wireless devices positioned within a geographical area associated with the second wireless device. In some examples, the messaging manager 425 is configurable or configured to communicate, during the time interval, with the one or more additional wireless devices via the subset of frequency resources based on the report and based on the one or more additional wireless devices being positioned within the same geographical area as the second wireless device.

In some examples, the interference report receiving manager 430 is configurable or configured to receive, from the second wireless device, a second report indicating interference at the second wireless device within the subset of frequency resources. In some examples, the punctured BW report transmitting manager 435 is configurable or configured to transmit, to the second wireless device based on the second report, a second control message comprising a second selected punctured bandwidth bitmap indicating that the first wireless device supports communication over a second subset of frequency resources of the set of frequency resources that excludes the at least one sub-band. In some examples, the messaging manager 425 is configurable or configured to communicate, during an additional time interval, with the second wireless device via the second subset of frequency resources based on transmitting the second control message.

In some examples, the interference indicated via the report includes interference experienced by the second wireless device due to signals from an additional wireless device, future interference expected to be experienced by the second wireless device due to communications at the second wireless device associated with a different radio access technology, or both.

In some examples, the one or more messages are communicated with the second and third wireless devices via a Wi-Fi communications protocol.

In some examples, the first wireless device includes an AP. In some examples, the second wireless device, the third wireless device, or both, include STAs.

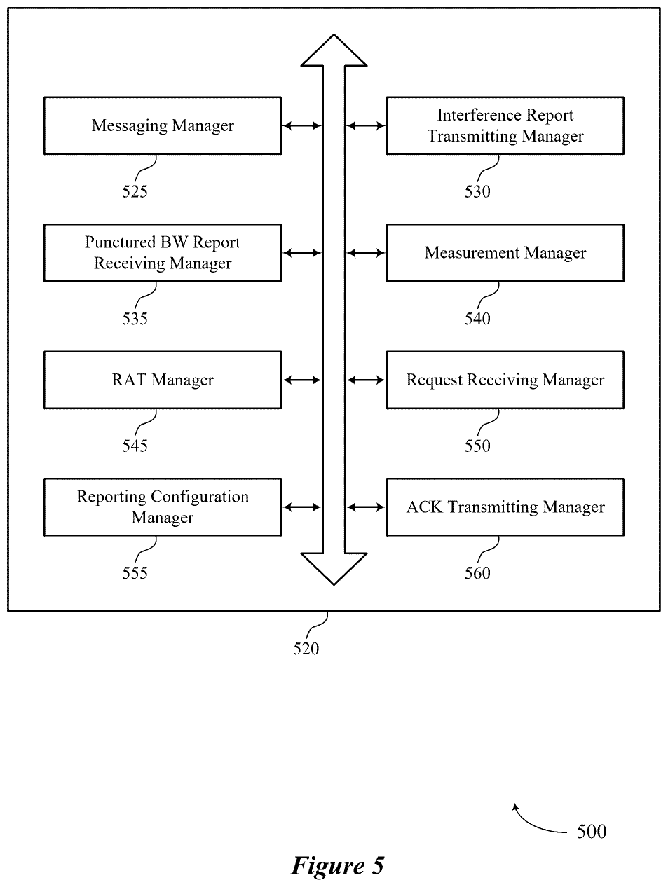

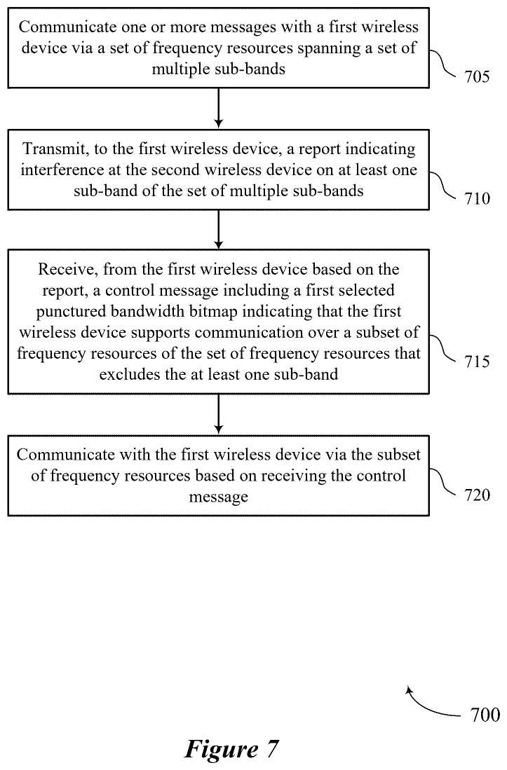

FIG. 5 shows a block diagram of an example wireless communication device 500 that supports techniques for dynamic puncturing on selective wireless clients to mitigate interference. In some examples, the wireless communication device 500 is configured to perform the process 700 described with reference to FIG. 7. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 500 may transmit the information output from the chip. In such an example, the second interface may refer to an interface between the processing system of the chip and a reception component, such that the wireless communication device 500 may receive information that is then passed to the processing system. In some such examples, the first interface also may obtain information, such as from the transmission component, and the second interface also may output information, such as to the reception component.

The processing system of the wireless communication device 500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 500 can be configurable or configured for use in a STA, such as the STA 104 described with reference to FIG. 1. In some other examples, the wireless communication device 500 can be a STA that includes such a processing system and other components including multiple antennas. The wireless communication device 500 is capable of transmitting and receiving wireless communications in the form of, for example, wireless packets. For example, the wireless communication device 500 can be configurable or configured to transmit and receive packets in the form of physical layer PPDUs and MPDUs conforming to one or more of the IEEE 802.11 family of wireless communication protocol standards. In some other examples, the wireless communication device 500 can be configurable or configured to transmit and receive signals and communications conforming to one or more 3GPP specifications including those for 5G NR or 6G. In some examples, the wireless communication device 500 also includes or can be coupled with one or more application processors which may be further coupled with one or more other memories. In some examples, the wireless communication device 500 further includes a user interface (UI) (such as a touchscreen or keypad) and a display, which may be integrated with the UI to form a touchscreen display that is coupled with the processing system. In some examples, the wireless communication device 500 may further include one or more sensors such as, for example, one or more inertial sensors, accelerometers, temperature sensors, pressure sensors, or altitude sensors, that are coupled with the processing system.

The wireless communication device 500 includes a messaging manager 525, an interference report transmitting manager 530, a punctured BW report receiving manager 535, a measurement manager 540, a RAT manager 545, a request receiving manager 550, a reporting configuration manager 555, and an ACK transmitting manager 560. Portions of one or more of the messaging manager 525, the interference report transmitting manager 530, the punctured BW report receiving manager 535, the measurement manager 540, the RAT manager 545, the request receiving manager 550, the reporting configuration manager 555, and the ACK transmitting manager 560 may be implemented at least in part in hardware or firmware. For example, one or more of the messaging manager 525, the interference report transmitting manager 530, the punctured BW report receiving manager 535, the measurement manager 540, the RAT manager 545, the request receiving manager 550, the reporting configuration manager 555, and the ACK transmitting manager 560 may be implemented at least in part by at least a processor or a modem. In some examples, portions of one or more of the messaging manager 525, the interference report transmitting manager 530, the punctured BW report receiving manager 535, the measurement manager 540, the RAT manager 545, the request receiving manager 550, the reporting configuration manager 555, and the ACK transmitting manager 560 may be implemented at least in part by a processor and software in the form of processor-executable code stored in memory.

The messaging manager 525 is configurable or configured to communicate one or more messages with a first wireless device via a set of frequency resources spanning a set of multiple sub-bands. The interference report transmitting manager 530 is configurable or configured to transmit, to the first wireless device, a report indicating interference at the second wireless device on at least one sub-band of the set of multiple sub-bands. The punctured BW report receiving manager 535 is configurable or configured to receive, from the first wireless device based on the report, a control message comprising a first selected punctured bandwidth bitmap indicating that the first wireless device supports communication over a subset of frequency resources of the set of frequency resources that excludes the at least one sub-band. In some examples, the messaging manager 525 is configurable or configured to communicate with the first wireless device via the subset of frequency resources based on receiving the control message.

In some examples, the measurement manager 540 is configurable or configured to perform measurements on signals received from a third wireless device. In some examples, the measurement manager 540 is configurable or configured to determine the interference at the second wireless device within the set of frequency resources based on the measurements, where transmitting the report is based on a level of the interference satisfying a threshold interference level.

In some examples, the RAT manager 545 is configurable or configured to identify one or more additional messages to be communicated by the second wireless device during a future time interval via a second radio access technology within the set of frequency resources, where the report indicates expected interference at the second wireless device during the future time interval between the first radio access technology and the second radio access technology.

In some examples, to support receiving the control message, the punctured BW report receiving manager 535 is configurable or configured to receive, via the control message, an IE associated with the first wireless device, where the IE indicates the subset of frequency resources using one or more dedicated bit fields for indicating punctured BWs.

In some examples, the control message indicating the subset of frequency resources includes a WNM report. In some examples, the subset of frequency resources are indicated via one or more bit fields of the WNM report.

In some examples, the request receiving manager 550 is configurable or configured to receive, from the first wireless device, a request for information associated with the interference at the second wireless device, where the report is transmitted in response to the request.

In some examples, the request is received in accordance with a polling periodicity.

In some examples, the request receiving manager 550 is configurable or configured to receive an additional request from the first wireless device in accordance with a second polling periodicity that adjusted relative to the polling periodicity based on the report indicating the interference at the second wireless device.

In some examples, the reporting configuration manager 555 is configurable or configured to receive, from the first wireless device, control signaling indicating a reporting configuration for transmitting reports associated with interference at the respective second and third wireless devices, where the report is transmitted in accordance with the reporting configuration.

In some examples, the report includes a CI report, a BQR, or both.

In some examples, the ACK transmitting manager 560 is configurable or configured to transmit, to the first wireless device, an ACK of the subset of frequency resources, where communicating with the first wireless device via the subset of frequency resources is based on transmitting the ACK.

In some examples, the interference report transmitting manager 530 is configurable or configured to transmit, to the first wireless device, a second report indicating interference at the second wireless device within the subset of frequency resources. In some examples, the punctured BW report receiving manager 535 is configurable or configured to receive, from the first wireless device based on the second report, a second control message comprising a second selected punctured bandwidth bitmap indicating that the first wireless device supports communication over a second subset of frequency resources of the set of frequency resources that excludes the at least one sub-band. In some examples, the messaging manager 525 is configurable or configured to communicate, during an additional time interval, with the first wireless device via the second subset of frequency resources based on receiving the second control message.

In some examples, the interference indicated via the report includes interference experienced by the second wireless device due to signals from an additional wireless device, future interference expected to be experienced by the second wireless device due to communications at the second wireless device associated with a different radio access technology, or both.

In some examples, the one or more messages are communicated with the first wireless devices via a Wi-Fi communications protocol.

In some examples, the first wireless device includes an AP. In some examples, the second wireless device includes a STA.

FIG. 6 shows a flowchart illustrating an example process 600 performable by or at a first wireless device that supports techniques for dynamic puncturing on selective wireless clients to mitigate interference. The operations of the process 600 may be implemented by a first wireless device or its components as described herein. For example, the process 600 may be performed by a wireless communication device, such as the wireless communication device 400 described with reference to FIG. 4, operating as or within a wireless AP. In some examples, the process 600 may be performed by a wireless AP, such as one of the APs 102 described with reference to FIG. 1.

In some examples, in 605, the first wireless device may communicate one or more messages with a second wireless device and a third wireless device via a set of frequency resources spanning a set of multiple sub-bands. The operations of 605 may be performed in accordance with examples as disclosed herein. In some implementations, aspects of the operations of 605 may be performed by a messaging manager 425 as described with reference to FIG. 4.

In some examples, in 610, the first wireless device may receive, from the second wireless device, a report indicating interference at the second wireless device on at least one sub-band of the set of multiple sub-bands. The operations of 610 may be performed in accordance with examples as disclosed herein. In some implementations, aspects of the operations of 610 may be performed by an interference report receiving manager 430 as described with reference to FIG. 4.

In some examples, in 615, the first wireless device may transmit, to the second wireless device based on the report, a control message comprising a first selected punctured bandwidth bitmap indicating that the first wireless device supports communication over a subset of frequency resources of the set of frequency resources that excludes the at least one sub-band. The operations of 615 may be performed in accordance with examples as disclosed herein. In some implementations, aspects of the operations of 615 may be performed by a punctured BW report transmitting manager 435 as described with reference to FIG. 4.

In some examples, in 620, the first wireless device may communicate, during a time interval, with the second wireless device via the subset of frequency resources based on transmitting the control message. The operations of 620 may be performed in accordance with examples as disclosed herein. In some implementations, aspects of the operations of 620 may be performed by a messaging manager 425 as described with reference to FIG. 4.

In some examples, in 625, the first wireless device may communicate, during the time interval, with the third wireless device via the set of frequency resources. The operations of 625 may be performed in accordance with examples as disclosed herein and the control message transmitted in 615. In some implementations, aspects of the operations of 625 may be performed by a messaging manager 425 as described with reference to FIG. 4.

FIG. 7 shows a flowchart illustrating an example process 700 performable by or at a second wireless device that supports techniques for dynamic puncturing on selective wireless clients to mitigate interference. The operations of the process 700 may be implemented by a second wireless device or its components as described herein. For example, the process 700 may be performed by a wireless communication device, such as the wireless communication device 500 described with reference to FIG. 5, operating as or within a wireless STA. In some examples, the process 700 may be performed by a wireless STA, such as one of the STAs 104 described with reference to FIG. 1.

In some examples, in 705, the second wireless device may communicate one or more messages with a first wireless device via a set of frequency resources spanning a set of multiple sub-bands. The operations of 705 may be performed in accordance with examples as disclosed herein. In some implementations, aspects of the operations of 705 may be performed by a messaging manager 525 as described with reference to FIG. 5.

In some examples, in 710, the second wireless device may transmit, to the first wireless device, a report indicating interference at the second wireless device on at least one sub-band of the set of multiple sub-bands. The operations of 710 may be performed in accordance with examples as disclosed herein. In some implementations, aspects of the operations of 710 may be performed by an interference report transmitting manager 530 as described with reference to FIG. 5.

In some examples, in 715, the second wireless device may receive, from the first wireless device based on the report, a control message comprising a first selected punctured bandwidth bitmap indicating that the first wireless device supports communication over a subset of frequency resources of the set of frequency resources that excludes the at least one sub-band. The operations of 715 may be performed in accordance with examples as disclosed herein. In some implementations, aspects of the operations of 715 may be performed by a punctured BW report receiving manager 535 as described with reference to FIG. 5.

In some examples, in 720, the second wireless device may communicate with the first wireless device via the subset of frequency resources based on receiving the control message. The operations of 720 may be performed in accordance with examples as disclosed herein. In some implementations, aspects of the operations of 720 may be performed by a messaging manager 525 as described with reference to FIG. 5.

Implementation examples are described in the following numbered clauses:

The following provides an overview of aspects of the present disclosure:

Aspect 1: A method for wireless communications at a first wireless device, comprising: communicating one or more messages with a second wireless device and a third wireless device via a set of frequency resources spanning a plurality of sub-bands; receiving, from the second wireless device, a report indicating interference at the second wireless device on at least one sub-band of the plurality of sub-bands; transmitting, to the second wireless device based at least in part on the report, a control message comprising a first selected punctured bandwidth bitmap indicating that the first wireless device supports communication over a subset of frequency resources of the set of frequency resources that excludes the at least one sub-band; communicating, during a time interval, with the second wireless device via the subset of frequency resources based at least in part on transmitting the control message; and communicating, during the time interval, with the third wireless device via the set of frequency resources.

Aspect 2: The method of aspect 1, where transmitting the control message includes: transmitting, via the control message, an IE associated with the first wireless device, where the IE indicates the subset of frequency resources using one or more dedicated bit fields for indicating punctured BWs.

Aspect 3: The method of any of aspects 1-2, where the control message indicating the subset of frequency resources includes a WNM report, the subset of frequency resources are indicated via one or more bit fields of the WNM report.

Aspect 4: The method of any of aspects 1-3, further comprising: transmitting, to the second wireless device, a request for information associated with the interference at the second wireless device, where the report is received in response to the request.

Aspect 5: The method of aspect 4, where the request is transmitted in accordance with a polling periodicity.

Aspect 6: The method of aspect 5, further comprising: adjusting the polling periodicity to generate an updated polling periodicity based at least in part on receiving the report indicating the interference at the second wireless device; and transmitting an additional request to the second wireless device in accordance with the updated polling periodicity.

Aspect 7: The method of any of aspects 1-6, further comprising: transmitting, to the second wireless device, a first set of requests for information associated with the interference at the second wireless device, where the report is received in response to the first set of requests, and where the first set of requests are transmitted in accordance with a first polling periodicity associated with a first geographical area of the second wireless device relative to the first wireless device; and transmitting, to the third wireless device, a second set of requests for information associated with interference at the third wireless device, where the second set of requests are transmitted in accordance with a second polling periodicity associated with a second geographical area of the third wireless device relative to the first wireless device, the second polling periodicity different from the first polling periodicity.

Aspect 8: The method of aspect 7, where the first polling periodicity is based at least in part on one or more reports indicating interference at wireless devices positioned within the first geographical area, and the second polling periodicity is based at least in part on one or more additional reports indicating interference at wireless devices positioned within the second geographical area.

Aspect 9: The method of any of aspects 1-8, further comprising: transmitting, to the second wireless device, the third wireless device, or both, control signaling indicating a reporting configuration for transmitting reports associated with interference at the respective second and third wireless devices, where the report is received in accordance with the reporting configuration.

Aspect 10: The method of any of aspects 1-9, where the report includes a collocated interference report, a BQR, or both.

Aspect 11: The method of any of aspects 1-11, further comprising: transmitting, to the third wireless device based at least in part on a second report from the third wireless device, a further control message comprising a second selected punctured bandwidth bitmap indicating that the first wireless device supports communication over the set of frequency resources, wherein the first selected punctured bandwidth bitmap and the second selected punctured bandwidth bitmap are different.

Aspect 12: The method of any of aspects 1-11, further comprising: receiving, from the second wireless device, an acknowledgment of the subset of frequency resources, where communicating with the second wireless device during the time interval via the subset of frequency resources is based at least in part on receiving the acknowledgment.

Aspect 13: The method of any of aspects 1-12, further comprising: identifying one or more additional wireless devices positioned within a geographical area associated with the second wireless device; and communicating, during the time interval, with the one or more additional wireless devices via the subset of frequency resources based at least in part on the report and based at least in part on the one or more additional wireless devices being positioned within the same geographical area as the second wireless device.

Aspect 14: The method of any of aspects 1-13, further comprising: receiving, from the second wireless device, a second report indicating interference at the second wireless device within the subset of frequency resources; transmitting, to the second wireless device based at least in part on the second report, a second control message comprising a second selected punctured bandwidth bitmap indicating that the first wireless device supports communication over a second subset of frequency resources of the set of frequency resources that excludes the at least one sub-band; and communicating, during an additional time interval, with the second wireless device via the second subset of frequency resources based at least in part on transmitting the second control message.

Aspect 15: The method of any of aspects 1-14, where the interference indicated via the report includes interference experienced by the second wireless device due to signals from an additional wireless device, future interference expected to be experienced by the second wireless device due to communications at the second wireless device associated with a different RAT, or both.

Aspect 16: The method of any of aspects 1-15, where the one or more messages are communicated with the second and third wireless devices via a Wi-Fi communications protocol.

Aspect 17: The method of any of aspects 1-16, where the first wireless device includes an BQR, and the second wireless device, the third wireless device, or both, include STAs.

Aspect 18: A method for wireless communications at a second wireless device, comprising: communicating one or more messages with a first wireless device via a set of frequency resources spanning a plurality of sub-bands; transmitting, to the first wireless device, a report indicating interference at the second wireless device on at least one sub-band of the plurality of sub-bands; receiving, from the first wireless device based at least in part on the report, a control message indicating a subset of frequency resources of the set of frequency resources that excludes the at least one sub-band; and communicating with the first wireless device via the subset of frequency resources based at least in part on receiving the control message.

Aspect 19: The method of aspect 18, further comprising: performing measurements on signals received from a third wireless device; and determining the interference at the second wireless device within the set of frequency resources based at least in part on the measurements, where transmitting the report is based at least in part on a level of the interference satisfying a threshold interference level.

Aspect 20: The method of any of aspects 18-19, where the one or more messages are communicated with the first wireless device via a first RAT, the method further comprising: identifying one or more additional messages to be communicated by the second wireless device during a future time interval via a second RAT within the set of frequency resources, where the report indicates expected interference at the second wireless device during the future time interval between the first RAT and the second RAT.

Aspect 21: The method of any of aspects 18-20, where receiving the control message includes: receiving, via the control message, an IE associated with the first wireless device, where the IE indicates the subset of frequency resources using one or more dedicated bit fields for indicating punctured BWs.

Aspect 22: The method of any of aspects 18-21, where the control message indicating the subset of frequency resources includes a WNM report, the subset of frequency resources are indicated via one or more bit fields of the WNM report.

Aspect 23: The method of any of aspects 18-22, further comprising: receiving, from the first wireless device, a request for information associated with the interference at the second wireless device, where the report is transmitted in response to the request.

Aspect 24: The method of aspect 23, where the request is received in accordance with a polling periodicity.

Aspect 25: The method of aspect 24, further comprising: receiving an additional request from the first wireless device in accordance with a second polling periodicity that adjusted relative to the polling periodicity based at least in part on the report indicating the interference at the second wireless device.

Aspect 26: The method of any of aspects 18-25, further comprising: receiving, from the first wireless device, control signaling indicating a reporting configuration for transmitting reports associated with interference at the respective second and third wireless devices, where the report is transmitted in accordance with the reporting configuration.

Aspect 27: The method of any of aspects 18-26, where the report includes a collocated interference report, a BQR, or both.

Aspect 28: The method of any of aspects 18-27, where the report includes a

bitmap indicating interference at the second wireless device within the plurality of sub-bands.

Aspect 29: The method of any of aspects 18-28, further comprising: transmitting, to the first wireless device, an acknowledgment of the subset of frequency resources, where communicating with the first wireless device via the subset of frequency resources is based at least in part on transmitting the acknowledgment.

Aspect 30: The method of any of aspects 18-29, further comprising: transmitting, to the first wireless device, a second report indicating interference at the second wireless device within the subset of frequency resources; receiving, from the first wireless device based at least in part on the second report, a second control message comprising a second selected punctured bandwidth bitmap indicating that the first wireless device supports communication over a second subset of frequency resources of the set of frequency resources that excludes the at least one sub-band; and communicating, during an additional time interval, with the first wireless device via the second subset of frequency resources based at least in part on receiving the second control message.

Aspect 31: The method of any of aspects 18-30, where the interference indicated via the report includes interference experienced by the second wireless device due to signals from an additional wireless device, future interference expected to be experienced by the second wireless device due to communications at the second wireless device associated with a different RAT, or both.

Aspect 32: The method of any of aspects 18-31, where the one or more messages are communicated with the first wireless devices via a Wi-Fi communications protocol.

Aspect 33: The method of any of aspects 18-32, where the first wireless device includes an BQR, and the second wireless device includes a STA.

Aspect 34: A first wireless device comprising one or more memories storing processor-executable code, and one or more processors coupled with the one or more memories and individually or collectively operable to execute the code to cause the first wireless device to perform a method of any of aspects 1-17.

Aspect 35: A first wireless device comprising at least one means for performing a method of any of aspects 1-17.

Aspect 36: A non-transitory computer-readable medium storing code the code comprising instructions executable by one or more processors to perform a method of any of aspects 1-17.

Aspect 37: A second wireless device comprising one or more memories storing processor-executable code, and one or more processors coupled with the one or more memories and individually or collectively operable to execute the code to cause the second wireless device to perform a method of any of aspects 18-33.

Aspect 38: A second wireless device comprising at least one means for performing a method of any of aspects 18-33.

Aspect 39: A non-transitory computer-readable medium storing code the code comprising instructions executable by one or more processors to perform a method of any of aspects 18-33.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,” or the equivalent in context, whatever it is that is “based on ‘a,”” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
one or more memories storing processor-executable code; and
one or more processors coupled with the one or more memories and individually or collectively operable to execute the code to cause the first wireless device to:
communicate one or more messages with a second wireless device and a third wireless device via a set of frequency resources spanning a plurality of sub-bands;
receive, from the second wireless device, a report indicating interference at the second wireless device on at least one sub-band of the plurality of sub-bands;
transmit, to the second wireless device based at least in part on the report, a control message comprising a first selected punctured bandwidth bitmap indicating that the first wireless device supports communication over a subset of frequency resources of the set of frequency resources that excludes the at least one sub-band;
communicate, during a time interval, with the second wireless device via the subset of frequency resources based at least in part on transmitting the control message; and
communicate, during the time interval, with the third wireless device via the set of frequency resources.

2. The first wireless device of claim 1, wherein, to transmit the control message, the one or more processors are individually or collectively operable to execute the code to cause the first wireless device to:
transmit, via the control message, an information element associated with the first wireless device, wherein the information element indicates the subset of frequency resources using one or more dedicated bit fields for indicating punctured bandwidths.

3. The first wireless device of claim 1, wherein the control message indicating the subset of frequency resources comprises a wireless network management report, wherein the subset of frequency resources are indicated via one or more bit fields of the wireless network management report.

4. The first wireless device of claim 1, wherein the one or more processors are individually or collectively further operable to execute the code to cause the first wireless device to:
transmit, to the second wireless device, a request for information associated with the interference at the second wireless device, wherein the report is received in response to the request.

5. The first wireless device of claim 4, wherein the request is transmitted in accordance with a polling periodicity.

6. The first wireless device of claim 5, wherein the one or more processors are individually or collectively further operable to execute the code to cause the first wireless device to:
adjust the polling periodicity to generate an updated polling periodicity based at least in part on receiving the report indicating the interference at the second wireless device; and
transmit an additional request to the second wireless device in accordance with the updated polling periodicity.

7. The first wireless device of claim 1, wherein the one or more processors are individually or collectively further operable to execute the code to cause the first wireless device to:
transmit, to the second wireless device, a first set of requests for information associated with the interference at the second wireless device, wherein the report is received in response to the first set of requests, and wherein the first set of requests are transmitted in accordance with a first polling periodicity associated with a first geographical area of the second wireless device relative to the first wireless device; and
transmit, to the third wireless device, a second set of requests for information associated with interference at the third wireless device, wherein the second set of requests are transmitted in accordance with a second polling periodicity associated with a second geographical area of the third wireless device relative to the first wireless device, the second polling periodicity different from the first polling periodicity.

8. The first wireless device of claim 7, wherein the first polling periodicity is based at least in part on one or more reports indicating interference at wireless devices positioned within the first geographical area, and wherein the second polling periodicity is based at least in part on one or more additional reports indicating interference at wireless devices positioned within the second geographical area.

9. The first wireless device of claim 1, wherein the one or more processors are individually or collectively further operable to execute the code to cause the first wireless device to:
transmit, to the second wireless device, the third wireless device, or both, control signaling indicating a reporting configuration for transmitting reports associated with interference at the respective second and third wireless devices, wherein the report is received in accordance with the reporting configuration.

10. The first wireless device of claim 1, wherein the report comprises a collocated interference report, a bandwidth query report, or both.

11. The first wireless device of claim 1, wherein the one or more processors are individually or collectively further operable to execute the code to cause the first wireless device to:
transmit, to the third wireless device based at least in part on a second report from the third wireless device, a further control message comprising a second selected punctured bandwidth bitmap indicating that the first wireless device supports communication over the set of frequency resources, wherein the first selected punctured bandwidth bitmap and the second selected punctured bandwidth bitmap are different.

12. The first wireless device of claim 1, wherein the one or more processors are individually or collectively further operable to execute the code to cause the first wireless device to:
receive, from the second wireless device, an acknowledgment of the subset of frequency resources, wherein communicating with the second wireless device during the time interval via the subset of frequency resources is based at least in part on receiving the acknowledgment.

13. The first wireless device of claim 1, wherein the one or more processors are individually or collectively further operable to execute the code to cause the first wireless device to:
identify one or more additional wireless devices positioned within a geographical area associated with the second wireless device; and
communicate, during the time interval, with the one or more additional wireless devices via the subset of frequency resources based at least in part on the report and based at least in part on the one or more additional wireless devices being positioned within a same geographical area as the second wireless device.

14. The first wireless device of claim 1, wherein the one or more processors are individually or collectively further operable to execute the code to cause the first wireless device to:
receive, from the second wireless device, a second report indicating interference at the second wireless device within the subset of frequency resources;
transmit, to the second wireless device based at least in part on the second report, a second control message comprising a second selected punctured bandwidth bitmap indicating that the first wireless device supports communication over a second subset of frequency resources of the set of frequency resources that excludes the at least one sub-band; and
communicate, during an additional time interval, with the second wireless device via the second subset of frequency resources based at least in part on transmitting the second control message.

15. The first wireless device of claim 1, wherein the interference indicated via the report comprises interference experienced by the second wireless device due to signals from an additional wireless device, future interference expected to be experienced by the second wireless device due to communications at the second wireless device associated with a different radio access technology, or both.

16. The first wireless device of claim 1, wherein the one or more messages and the control message are communicated with the second and third wireless devices via a Wi-Fi communications protocol.

17. The first wireless device of claim 1, wherein the first wireless device comprises an access point, and wherein the second wireless device, the third wireless device, or both, comprise wireless stations.

18. A second wireless device, comprising:
one or more memories storing processor-executable code; and
one or more processors coupled with the one or more memories and individually or collectively operable to execute the code to cause the second wireless device to:
communicate one or more messages with a first wireless device via a set of frequency resources spanning a plurality of sub-bands;
transmit, to the first wireless device, a report indicating interference at the second wireless device on at least one sub-band of the plurality of sub-bands;
receive, from the first wireless device based at least in part on the report, a control message comprising a first selected punctured bandwidth bitmap indicating that the first wireless device supports communication over a subset of frequency resources of the set of frequency resources that excludes the at least one sub-band; and
communicate with the first wireless device via the subset of frequency resources based at least in part on receiving the control message.

19. The second wireless device of claim 18, wherein the one or more processors are individually or collectively further operable to execute the code to cause the second wireless device to:
perform measurements on signals received from a third wireless device; and
determine the interference at the second wireless device within the set of frequency resources based at least in part on the measurements, wherein transmitting the report is based at least in part on a level of the interference satisfying a threshold interference level.

20. The second wireless device of claim 18, wherein the one or more processors are individually or collectively further operable to execute the code to cause the second wireless device to:
identify one or more additional messages to be communicated by the second wireless device during a future time interval via a second radio access technology within the set of frequency resources, wherein the report indicates expected interference at the second wireless device during the future time interval between a first radio access technology and the second radio access technology.

21. The second wireless device of claim 18, wherein, to receive the control message, the one or more processors are individually or collectively operable to execute the code to cause the second wireless device to:
receive, via the control message, an information element associated with the first wireless device, wherein the information element indicates the subset of frequency resources using one or more dedicated bit fields for indicating punctured bandwidths.

22. The second wireless device of claim 18, wherein the control message indicating the subset of frequency resources comprises a wireless network management report, wherein the subset of frequency resources are indicated via one or more bit fields of the wireless network management report.

23. A method for wireless communications at a first wireless device, comprising:
communicating one or more messages with a second wireless device and a third wireless device via a set of frequency resources spanning a plurality of sub-bands;
receiving, from the second wireless device, a report indicating interference at the second wireless device on at least one sub-band of the plurality of sub-bands;
transmitting, to the second wireless device based at least in part on the report, a control message comprising a first selected punctured bandwidth bitmap indicating that the first wireless device supports communication over a subset of frequency resources of the set of frequency resources that excludes the at least one sub-band;
communicating, during a time interval, with the second wireless device via the subset of frequency resources based at least in part on transmitting the control message; and
communicating, during the time interval, with the third wireless device via the set of frequency resources.

24. The method of claim 23, wherein transmitting the control message comprises:
transmitting, via the control message, an information element associated with the first wireless device, wherein the information element indicates the subset of frequency resources using one or more dedicated bit fields for indicating punctured bandwidths.

25. The method of claim 23, wherein the control message indicating the subset of frequency resources comprises a wireless network management report, wherein the subset of frequency resources are indicated via one or more bit fields of the wireless network management report.

26. The method of claim 23, further comprising:
transmitting, to the second wireless device, a request for information associated with the interference at the second wireless device, wherein the report is received in response to the request.

27. The method of claim 26, wherein the request is transmitted in accordance with a polling periodicity, the method further comprising:
adjusting the polling periodicity to generate an updated polling periodicity based at least in part on receiving the report indicating the interference at the second wireless device; and
transmitting an additional request to the second wireless device in accordance with the updated polling periodicity.

28. A method for wireless communications at a second wireless device, comprising:
communicating one or more messages with a first wireless device via a set of frequency resources spanning a plurality of sub-bands;
transmitting, to the first wireless device, a report indicating interference at the second wireless device on at least one sub-band of the plurality of sub-bands;
receiving, from the first wireless device based at least in part on the report, a control message comprising a first selected punctured bandwidth bitmap indicating that the first wireless device supports communication over a subset of frequency resources of the set of frequency resources that excludes the at least one sub-band; and
communicating with the first wireless device via the subset of frequency resources based at least in part on receiving the control message.

29. The method of claim 28, further comprising:
performing measurements on signals received from a third wireless device; and
determining the interference at the second wireless device within the set of frequency resources based at least in part on the measurements, wherein transmitting the report is based at least in part on a level of the interference satisfying a threshold interference level.

30. The method of claim 28, wherein the one or more messages are communicated with the first wireless device via a first radio access technology, the method further comprising:
identifying one or more additional messages to be communicated by the second wireless device during a future time interval via a second radio access technology within the set of frequency resources, wherein the report indicates expected interference at the second wireless device during the future time interval between the first radio access technology and the second radio access technology.
